(19) United States
(12) Patent Application Publication
(10) Pub. No.: US 2006/0009578 A1
(43) Pub. Date: Jan. 12, 2006

(54) Compositions containing maleimide-substituted silsesquioxanes and methods for use thereof

(76) Inventor: Stephen M. Dershem, San Diego, CA (US)

Correspondence Address: Kevin Forrestal Designer Molecules Inc., 10080 Willow Creek Rd., San Diego, CA, 92131, US

(21) Appl. No.: 11/176,107

(22) Filed: Jul. 7, 2005

Related U.S. Application Data
(60) Provisional application No. 60/585,897, filed on Jul. 7, 2004.

(51) Int. Cl. C08L 83/04; C08G 77/04; B32B 27/00

(52) U.S. Cl. 524/863; 528/25; 528/33; 428/447

(57) ABSTRACT

The present invention is based on the discovery that maleimide-substituted polyhedralsilsesquioxane compounds are useful as components in photosensistive resin compositions. These compounds can be readily prepared from available precursors, and are easily incorporated into resin compositions by appropriate formulating conditions. The incorporation of a variety of polyhedralsilsesquioxane frameworks into a photosensitive resin composition is readily accomplished via the crosslinkable maleimide moiety, which crosslinks under a variety of conditions (e.g., chemically and radiatively). Indeed, the compounds described herein contain at least one maleimide moiety attached to a polyhedralsilsesquioxane framework.

### RELATED APPLICATIONS

This application claims the benefit of priority of U.S. Provisional Application Ser. No. 60/585,897 filed Jul. 7, 2004, the entire disclosure of which is incorporated herein by reference.

### FIELD OF THE INVENTION

The present invention relates generally to polyhedralsilsesquioxanes bearing polymerizable moieties and uses therefore, and more particularly to maleimide-substituted polyhedralsilsesquioxanes and thermosetting resin compositions including such polyhedralsilsesquioxanes.

### BACKGROUND OF THE INVENTION

As the electronics industry advances, and production of light weight components increases, the development of new materials gives producers increased options for further improving the performance and ease of manufacture of such components. Materials used in the manufacture of electronic components include the resin required for the preparation of prepregs (which are, in turn, used for the preparation of multilayered printed circuit boards and printed wiring boards), resins used for the preparation of solder masks (which define solder areas on the multilayered printed wiring board), and resins used for preparation of glob top (which protects microelectronic devices from the environment).

Multilayered printed circuit boards are currently produced mainly by (a) a mass laminating technique and (b) a pin laminating technique. In these techniques, a printed circuit board for inner layer use (hereinafter, referred to as “inner-layer board”) is first manufactured. This inner-layer board is combined with prepregs and then a copper foil or a single-side copper-clad laminate and the superimposed laminating materials are laminated to give a multilayered board, both sides of which are covered by a copper coating. This multilayered structure is processed as appropriate to form through-holes, outer-layer printed circuits, etc.

The initial manufacture of resins used in laminates is usually conducted by chemical producers and supplied to the trade in a workable form. Addition of a curing agent or catalyst, as well as optional components such as diluents, flow promoters, fire retardants, and other modifying resins is typically performed by the user. This may be done in the interest of customization to the application or to ensure that pre-reaction of the formulation does not occur.

Another common use of resins in the electronics industry is for the preparation of solder masks. Solder mask is used to prevent excessive flow of solder in plastic packages. The material used must maintain the integrity of the physical, chemical, mechanical, and environmentally related properties of the package. Solder masks were originally intended to be used on printed wiring boards (PWBs) as an aid to manufacturing, reducing the need for touch-up after machine soldering, reducing solder consumption, and providing mechanical protection for the main portion of the circuitry.

The main type of solder mask employed in the art is the “liquid photoimageable” solder mask. There are three primary methods of applying this type of soldermask: flood screen-coating, curtain, and spray coating. Each method has both advantages and drawbacks. Screen coating, for example, is efficient in material usage, but through-holes may be plugged in the process. These holes must then be vacated during development. Curtain coating is also efficient, but it is a much slower process since only one side of a board can be coated at a time. Spray coating is the best method to accomplish complete fill and trace application, but this technique can result in substantial material losses (e.g., in the range of 10-30% waste).

To obtain higher resolution patterns, chemically amplified photoresists are generally used. These chemically amplified photoresists usually utilize a combination of a selected polymer resin such as a partially modified or protected poly(hydroxystyrene) resin or copolymer of a partially modified hydroxystyrene with other monomers such as acrylates or methacrylates, a photoacid generating compound (PAG), and a selected solvent.

More recently, researchers in the electronic materials industry have become interested in polyhedralsilsesquioxanes. Indeed, these materials exhibit a number of potentially useful properties including high temperature stability in air, good adhesion to a number of substrates, and resistance to oxidation and degradation by ultraviolet light. They may find use as protective coatings for electronic devices and other substrates and as precursors for ceramic coatings, foams, fibers, and articles.

For the applications described above, the microelectronics industry continues to require new resins which are able to meet its varying demands. Accordingly, there is a need for the development of new materials, such as new polyhedralsilsesquioxanes to address the requirements of this rapidly evolving industry.

### SUMMARY OF THE INVENTION

The present invention is based on the discovery that maleimide-substituted polyhedralsilsesquioxane compounds are useful as components in photosensistive resin compositions. These compounds can be readily prepared from available precursors, and are easily incorporated into resin compositions by appropriate formulating conditions. The incorporation of a variety of polyhedralsilsesquioxane frameworks into a photosensitive resin composition is readily accomplished via the crosslinkable maleimide moiety, which crosslinks under a variety of conditions (e.g., chemically and radiatively). Indeed, the compounds described herein contain at least one maleimide moiety attached to a polyhedralsilsesquioxane framework.

In one embodiment of the invention, there are provided compounds having the structure: 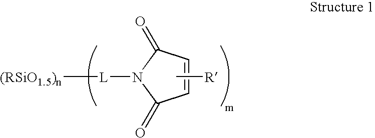
wherein:
   R is alkyl, alkenyl, aryl, or alkoxy;
   L is alkylene or oxyalkylene;
   R′ is H or alkyl;
   n is 6 to about 12; and
   m is 1 to about 12.

In another embodiment of the invention, there are provided photosensitive resin compositions including
a) a compound having the structure: 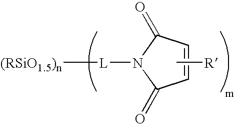
   wherein:
      R is alkyl, alkenyl, aryl, or alkoxy;
      L is alkylene or oxyalkylene;
      R′ is H or alkyl;
      n is 6 to about 12;
      m is 1 to about 12; and
b) a solvent.

In still another embodiment, there are provided polymers including a plurality of monomers having the structure: 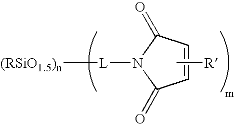
wherein:
   R is alkyl, alkenyl, aryl, or alkoxy;
   L is alkylene or oxyalkylene;
   R′ is H or alkyl;
   n is 6 to about 12; and
   m is 1 to about 12.

In another embodiment, there are provided adhesive compositions including at least one compound having the structure: 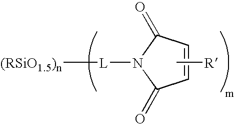
wherein:
   R is alkyl, alkenyl, aryl, or alkoxy;
   L is alkylene or oxyalkylene;
   R′ is H or alkyl;
   n is 6 to about 12; and
   m is 1 to about 12.

### DETAILED DESCRIPTION OF THE INVENTION

It is to be understood that both the foregoing general description and the following detailed description are exemplary and explanatory only and are not restrictive of the invention claimed. As used herein, the use of the singular includes the plural unless specifically stated otherwise. As used herein, “or” means “and/or” unless stated otherwise. Furthermore, use of the term “including” as well as other forms, such as “includes,” and “included,” is not limiting.

The section headings used herein are for organizational purposes only and are not to be construed as limiting the subject matter described. Unless specific definitions are provided, the nomenclatures utilized in connection with, and the laboratory procedures and techniques of analytical chemistry, synthetic organic and inorganic chemistry described herein are those known in the art. Standard chemical symbols are used interchangeably with the full names represented by such symbols. Thus, for example, the terms “hydrogen” and “H” are understood to have identical meaning. Standard techniques may be used for chemical syntheses, chemical analyses, and formulation.

The present invention is based on the discovery that maleimide-substituted polyhedralsilsesquioxane compounds are useful as components in photosensistive resin compositions. These compounds can be readily prepared from available precursors, and are easily incorporated into resin compositions by appropriate formulating conditions. The incorporation of a variety of polyhedralsilsesquioxane frameworks into a photosensitive resin composition is readily accomplished via the crosslinkable maleimide moiety, which crosslinks under a variety of conditions (e.g., chemically and radiatively). Indeed, the compounds described herein contain at least one maleimide moiety attached to a polyhedralsilsesquioxane framework.

As used herein, “aliphatic” refers to any alkyl, alkenyl, or cycloalkyl moiety.

As used herein, “alkyl” refers to straight or branched chain hydrocarbyl groups having from 1 up to about 100 carbon atoms. “Substituted alkyl” refers to alkyl moieties bearing substituents including alkyl, alkenyl, alkynyl, hydroxy, oxo, alkoxy, mercapto, cycloalkyl, substituted cycloalkyl, heterocyclic, substituted heterocyclic, aryl, substituted aryl, heteroaryl, substituted heteroaryl, aryloxy, substituted aryloxy, halogen, haloalkyl, cyano, nitro, nitrone, amino, amido, —C(O)H, —C(O)—, —C(O)—, —S—, —S(O)₂, —OC(O)—O—, —NR—C(O), —NR—C(O)—NR, —OC(O)—NR, wherein R is H or lower alkyl, acyl, oxyacyl, carboxyl, carbamate, sulfonyl, sulfonamide, sulfuryl, and the like.

As used herein, “cycloalkyl” refers to cyclic ring-containing groups containing in the range of about 5 up to about 20 carbon atoms, and “substituted cycloalkyl” refers to cycloalkyl groups further bearing one or more substituents as set forth above. In some embodiments, the cycloalkyl refers to cyclic ring-containing groups containing in the range of about 5 up to about 12 carbon atoms

As used herein, “aryl” refers to aromatic groups having in the range of 6 up to 14 carbon atoms and “substituted aryl” refers to aryl groups further bearing one or more substituents as set forth above.

As used herein, “heterocyclic” refers to cyclic (i.e., ring-containing) groups containing one or more heteroatoms (e.g., N, O, S, or the like) as part of the ring structure, and having in the range of 3 up to 14 carbon atoms and “substituted heterocyclic” refers to heterocyclic groups further bearing one or more substituents as set forth above. The term “heterocyclic” is also intended to refer to heteroaryl moieties.

As used herein, “alkenyl” refers to straight or branched chain hydrocarbyl groups having at least one carbon-carbon double bond, and having in the range of about 2 up to 100 carbon atoms, and “substituted alkenyl” refers to alkenyl groups further bearing one or more substituents as set forth above.

In one embodiment of the invention, there are provided compounds having the structure: 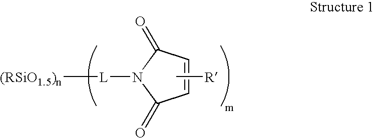
wherein:
   R is alkyl, alkenyl, aryl, or alkoxy;
   L is alkylene or oxyalkylene;
   R′ is H or alkyl;
   n is 6 to about 12; and
   m is 1 to about 12.

In some embodiments of the invention, R is C₁-C₁₂ alkyl, such as for example, methyl, ethyl, propyl, butyl, isobutyl, pentyl, hexyl, cyclohexyl, heptyl, octyl, and the like. In other embodiments, R is a cycloalkyl, such as, for example, cyclohexyl, cyclopentyl, norbornyl, and the like. In one embodiment, R is cyclohexyl.

A wide variety of linkers “L” are contemplated for use in the practice of the invention. In some embodiments, L is C₁-C₁₂ alkylene. In other embodiments, L is C₁-C₆ alkylene.

The polyhedralsilsesquioxane framework contemplated for use in the practice of the invention will vary depending on the particular application. In some embodiments, the variable “n” as set forth above is 6, 8, 10, or 12. Those skilled in the art recognize that each value of “n” gives rise to a particular geometrical shape for the polyhedralsilsesquioxane framework. Exemplary compounds of the invention are set forth below: 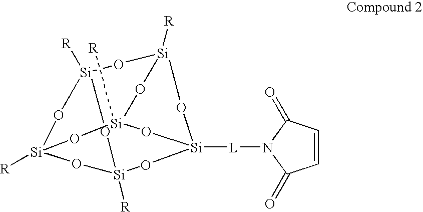
wherein:
   R is methyl, ethyl, propyl, butyl, isobutyl, pentyl, hexyl, cyclohexyl, heptyl, or octyl, and
   L is alkylene or oxyalkylene; 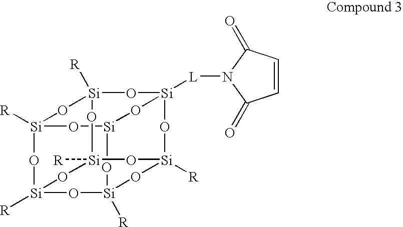
   wherein:
   R is methyl, ethyl, propyl, butyl, isobutyl, pentyl, hexyl, cyclohexyl, heptyl, or octyl, and
   L is alkylene or oxyalkylene; 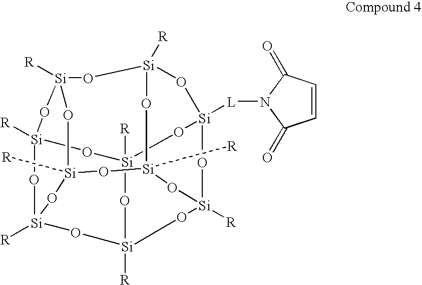
wherein:
   R is methyl, ethyl, propyl, butyl, isobutyl, pentyl, hexyl, cyclohexyl, heptyl, or octyl, and
   L is alkylene or oxyalkylene; 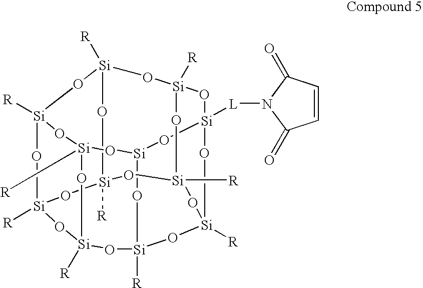
wherein:
   R is methyl, ethyl, propyl, butyl, isobutyl, pentyl, hexyl, cyclohexyl, heptyl, or octyl, and
   L is alkylene or oxyalkylene.

The compounds described above can be readily prepared by reacting a polyhedralsilsesquioxane bearing at least one primary amine moiety with maleic anhydride. Conversion of primary amines to maleimides is well-known to those skilled in the art and is described in U.S. Pat. No. 5,973,166, the entire contents of which is incorporated herein by reference. Preparation of suitable polyhedralsilsesquioxanes is described for example, in U.S. Pat. Nos. 5,412,053 and 5,484,867, the entire contents of each of which are incorporated herein by reference.

In another embodiment of the invention, there are provided photosensitive resin compositions including
a) a compound having the structure: 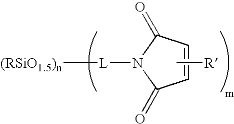
   wherein:
      R is alkyl, alkenyl, aryl, or alkoxy;
      L is alkylene or oxyalkylene;
      R′ is H or alkyl;
      n is 6 to about 12;
      m is 1 to about 12, and
c) a solvent.

Solvents contemplated for use in the practice of the invention are preferably inert, and should dissolve all components of the photosensitive composition. The solvent is ultimately removed after coating the composition onto a substrate. Exemplary solvents for use in the practice of the invention include, but are not limited to, 2-methoxy-1-propylene acetate, γ-butyrolactone, diglyme, tetrahydrofuran (THF), propylene glycol monomethyl etheracetate (PGMEA), propylene glycol monomethylether (PGME), methyl ethyl ketone, methyl isobutyl ketone, 2-heptanone, cyclopentanone, cyclehexanone, 2-methoxyethanol, 2-ethoxyothanol, 2-ethoxyethyl acetate, 1-methoxy-2-propyl acetate, 1,2-dimethoxy ethane ethyl acetate, cellosolve acetate, propylene glycol monoethyl ether acetate, methyl lactate, ethyl lactate, methyl pyruvate, ethyl pyruvate, methyl 3-methoxypropionate, ethyl 3-methoxypropionate, 1,4-dioxane, ethylene glycol monoisopropyl ether, diethylene glycol monoethyl ether, diethylene glycol monomethyl ether, diethylene glycol dimethyl ether, and the like.

Typically, the solvent is about 100 to 1000 parts by weight per 100 parts by weight of polymer in the photosensitive composition. In some embodiments, the solvent is about 200 to about 800 parts. In other embodiments, the solvent is about 400 to 700 parts by weight per 100 parts by weight of polymer in the photosensitive composition.

In other embodiments of the invention, the photosensitive resin composition includes a photosensitive agent. Typically, the photosensitive agent is about 2 weight percent (wt %) to about 10 wt % of the total composition. In some embodiments, the photosensitive resin composition includes a diluent.

In still another embodiment of the invention, there are provided polymers including a plurality of monomers having the structure: 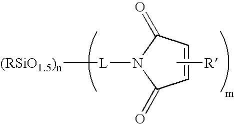
wherein:
   R is alkyl, alkenyl, aryl, or alkoxy;
   L is alkylene or oxyalkylene;
   R′ is H or alkyl;
   n is 6 to about 12; and
   m is 1 to about 12.

In another embodiment of the invention, there are provided adhesive compositions including at least one compound of Structure 1 and at least one curing initiator. The at least one curing initiator is typically present in the composition from 0.1 wt % to about 5 wt % based on total weight of the composition, and is typically a free-radical initiator. As used herein, the term “free radical initiator” refers to any chemical species which, upon exposure to sufficient energy (e.g., light, heat, or the like), decomposes into two parts which are uncharged, but which each possess at least one unpaired electron. Preferred free radical initiators contemplated for use in the practice of the present invention are compounds which decompose (i.e., have a half life in the range of about 10 hours) at temperatures in the range of about 70° C. up to 180° C. Exemplary free radical initiators contemplated for use in the practice of the present invention include peroxides (e.g., dicumyl peroxide, dibenzoyl peroxide, 2-butanone peroxide, tert-butyl perbenzoate, di-tert-butyl peroxide, 2,5-bis(tert-butylperoxy)-2,5-dimethylhexane, bis(tert-butyl peroxyisopropyl)benzene, and tert-butyl hydroperoxide), azo compounds (e.g., 2,2′-azobis(2-methyl-propanenitrile), 2,2′-azobis(2-methylbutanenitrile), and 1,1′-azobis(cyclohexanecarbonitrile)), and the like.

The term “free radical initiator” also includes photoinitiators. For example, for invention adhesive compositions that contain a photoinitiator, the curing process can be initiated by UV radiation. In one embodiment, the photoinitiator is present at a concentration of 0.1 wt % to 5 wt % based on the total weight of the organic compounds in the composition (excluding any filler). In one embodiment, the photoinitiator comprises 0.1 wt % to 3.0 wt %, based on the total weight of the organic compounds in the composition. Photoinitiators include benzoin derivatives, benzilketals, α,α-dialkoxyacetophenones, α-hydroxyalkylphenones, α-aminoalkylphenones, acylphosphine oxides, titanocene compounds, combinations of benzophenones and amines or Michler's ketone, and the like.

In another embodiment of the invention, there are provided adhesive compositions including 2 weight percent to about 98 weight percent (wt %) of at least one compound of Structure 1 described herein, or combinations thereof, based on total weight of the composition; optionally, 10 wt % to about 90 wt % of at least one additional compound selected from the group consisting of acrylates, methacrylates, maleimides, vinyl ethers, vinyl esters, styrenic compounds, and allyl functional compounds, and the like, based on total weight of the composition; 0 to about 90 wt % of a conductive filler; 0.1 wt % to about 5 wt % of at least one curing initiator, based on total weight of the composition; and 0.1 wt % to about 4 wt %, of at least one coupling agent, based on total weight of the composition. In some embodiments, the additional compound includes, for example, epoxies (such as phenolics, novalacs (both phenolic and cresolic) and the like), imides, monomaleimides, bismaleimides, polymaleimides, cyanate esters, vinyl ethers, vinyl esters, vinyl acetates, esters, ureas, amides, olefins (such as ethylenes, propylenes, and the like) siloxanes, cyanoacrylates, styrenes, and the like, or combinations thereof.

Fillers contemplated for use in the practice of the present invention can be electrically conductive and/or thermally conductive, and/or fillers which act primarily to modify the rheology of the resulting composition. Examples of suitable electrically conductive fillers which can be employed in the practice of the present invention include silver, nickel, copper, aluminum, palladium, gold, graphite, metal-coated graphite (e.g., nickel-coated graphite, copper-coated graphite, and the like), and the like. Examples of suitable thermally conductive fillers which can be employed in the practice of the present invention include graphite, aluminum nitride, silicon carbide, boron nitride, diamond dust, alumina, and the like. Compounds which act primarily to modify rheology include polysiloxanes (such as polydimethyl siloxanes) silica, fumed silica, alumina, titania, and the like.

As used herein, the term “coupling agent” refers to chemical species that are capable of bonding to a mineral surface and which also contain polymerizably reactive functional group(s) so as to enable interaction with the adhesive composition. Coupling agents thus facilitate linkage of the die-attach paste to the substrate to which it is applied.

Exemplary coupling agents contemplated for use in the practice of the present invention include silicate esters, metal acrylate salts (e.g., aluminum methacrylate), titanates (e.g., titanium methacryloxyethylacetoacetate triisopropoxide), or compounds that contain a copolymerizable group and a chelating ligand (e.g., phosphine, mercaptan, acetoacetate, and the like). In some embodiments, the coupling agents contain both a co-polymerizable function (e.g., vinyl moiety, acrylate moiety, methacrylate moiety, and the like), as well as a silicate ester function. The silicate ester portion of the coupling agent is capable of condensing with metal hydroxides present on the mineral surface of substrate, while the co-polymerizable function is capable of co-polymerizing with the other reactive components of invention die-attach paste. In certain embodiments coupling agents contemplated for use in the practice of the invention are oligomeric silicate coupling agents such as poly(methoxyvinylsiloxane).

In some embodiments, both photoinitiation and thermal initiation may be desirable. For example, curing of a photoinitiator-containing adhesive can be started by UV irradiation, and in a later processing step, curing can be completed by the application of heat to accomplish a free-radical cure. Both UV and thermal initiators may therefore be added to the adhesive composition.

In certain embodiments, the adhesive compositions may contain compounds that lend additional flexibility and toughness to the resultant cured adhesive. Such compounds may be any thermoset or thermoplastic material having a Tg of 50° C. or less, and typically will be a polymeric material characterized by free rotation about the chemical bonds, the presence of ether groups, and the absence of ring structures. Suitable such modifiers include polyacrylates, poly(butadiene), polyTHF (polymerized tetrahydrofuran, also known as poly(1,4-butanediol)), CTBN (carboxy-terminated butadiene-acrylonitrile) rubber, and polypropylene glycol. When present, toughening compounds may be in an amount up to about 15 percent by weight of the maleimide and other monofunctional vinyl compound.

Inhibitors for free-radial cure may also be added to the adhesive compositions described herein to extend the useful shelf life of compositions containing the compounds of Structure 1. Examples of these inhibitors include hindered phenols such as 2,6-di-tert-butyl-4-methylphenol; 2,6-di-tert-butyl-4-methoxyphenol; tert-butyl hydroquinone; tetrakis(methylene(3,5-di-tert-butyl-4-hydroxyhydrocinnamate))benzene; 2,2′-methylenebis(6-tert-butyl-p-cresol); and 1,3,5-trimethyl-2,4,6-tris(3′,5′-di-tert-butyl-4-hydroxybenzyl)benzene. Other useful hydrogen-donating antioxidants include derivatives of p-phenylenediamine and diphenylamine. It is also well know in the art that hydrogen-donating antioxidants may be synergistically combined with quinones, and metal deactivators to make a very efficient inhibitor package. Examples of suitable quinones include benzoquinone, 2-tert butyl-1,4-benzoquinone; 2-phenyl-1,4-benzoquinone; naphthoquinone, and 2,5-dichloro-1,4-benzoquinone. Examples of metal deactivators include N,N′-bis(3,5-di-tert-butyl-4-hydroxyhydrocinnamoyl)hydrazine; oxalyl bis(benzylidenehydrazide); and N-phenyl-N′-(4-toluenesulfonyl)-p-phenylenediamine. Nitroxyl radical compounds such as TEMPO (2,2,6,6-tetramethyl-1-piperidnyloxy, free radical) are also effective as inhibitors at low concentrations. The total amount of antioxidant plus synergists typically falls in the range of 100 to 2000 ppm relative to the weight of total base resin. Other additives, such as adhesion promoters, in types and amounts known in the art, may also be added.

In some embodiments, the compositions typically will perform within the commercially acceptable range for die attach adhesives. Commerically acceptable values for die shear for the adhesives on a 80×80 mil² silicon die are in the range of greater than or equal to 1 kg at room temperature, and greater than or equal to 0.5 kg at 240° C. Acceptable values for warpage for a 500×500 mil² die are in the range of less than or equal to 70 Nm at room temperature.

Conditions suitable to cure invention adhesive compositions include subjecting the above-described assembly to a temperature of less than about 200° C. for about 0.5 up to 2 minutes. This rapid, short duration heating can be accomplished in a variety of ways, e.g., with an in-line heated rail, a belt furnace, or the like. Optionally, the material can be oven cured at 150-220° C.

It is understood that using the compounds and methods of the present invention, it is possible to prepare adhesives having a wide range of cross-link density by the judicious choice and amount of the compounds of Structure 1. The greater proportion of polyfunctional compounds reacted, the greater the cross-link density. As used herein, “polyfunctional” means that there is more than one maleimide moiety attached to a single polyhedralsilsesquioxane framework. If thermoplastic properties are desired, the adhesive compositions can be prepared from (or at least contain a higher percentage of) mono-functional compounds to limit the cross-link density. A minor amount of poly-functional compounds can be added to provide some cross-linking and strength to the composition, provided the amount of poly-functional compounds is limited to an amount that does not diminish the desired thermoplastic properties. Within these parameters, the strength and elasticity of individual adhesives can be tailored to a particular end-use application.

“Cross-linking,” as used herein, refers to the attachment of two or more polymer chains by bridges of an element, a molecular group, or a compound. In general, crosslinking of the compounds of the invention takes place upon heating. As cross-linking density is increased, the properties of a material can be changed from thermoplastic to thermosetting.

The invention will now be further described with reference to the following non-limiting example.

### EXAMPLE

This example describes the synthesis of a maleimide-substituted polyhedralsilsesquioxane, wherein the alkyl groups attached to the polyhedralsilsesquioxane framework are isobutyl moieties. To a 250 mL round bottom flask was added methanesulfonic acid (12.0 g), toluene (89 g), triethylamine (10 g), and maleic anhydride (2.1 g). The amine substituted polyhedralsilsesquioxane AM0265 (15.5 g, available from Hybrid Plastics) was then added in portions to the mixture. The flask was equipped with a Dean-Stark trap and the mixture refluxed for two hours, at which time the expected amount of water collected in the Dean-Stark trap. The salt was extracted and the toluene solution passed over silica gel. Rotary evaporation of the toluene afforded the product in 79% yield (15.1 g). Infrared spectroscopy confirmed formation of the maleimide

While this invention has been described with respect to this specific example, it should be clear that other modifications and variations would be possible without departing from the spirit of this invention.

What is claimed is:

1. A compound having the structure: 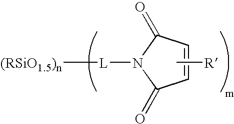
wherein:
R is alkyl, alkenyl, aryl, or alkoxy;
L is alkylene or oxyalkylene;
R′ is H or alkyl;
n is 6 to about 12; and
m is 1 to about 12.

2. The compound of claim 1, wherein R is C₁-C₁₂ alkyl.

3. The compound of claim 1, wherein R is methyl, ethyl, propyl, butyl, pentyl, hexyl, cyclohexyl, heptyl, or octyl.

4. The compound of claim 1, wherein R is cyclohexyl.

5. The compound of claim 1, wherein L is C₁-C₁₂ alkylene.

6. The compound of claim 1, wherein, L is C₁-C₆ alkylene.

7. The compound of claim 1, wherein n is 6, 8, or 10.

8. The compound of claim 1, having the structure: 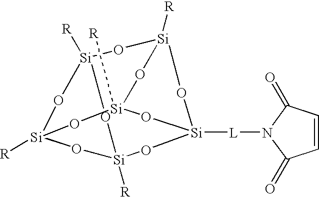
wherein:
R is methyl, ethyl, propyl, butyl, pentyl, hexyl, cyclohexyl, heptyl, or octyl, and
L is alkylene or oxyalkylene.

9. The compound of claim 8, wherein R is cyclohexyl.

10. The compound of claim 1, having the structure: 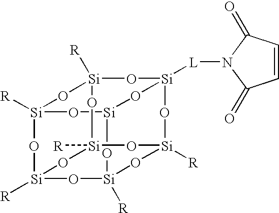
wherein:
R is methyl, ethyl, propyl, butyl, pentyl, hexyl, cyclohexyl, heptyl, or octyl, and
L is alkylene or oxyalkylene.

11. The compound of claim 10, wherein R is cyclohexyl.

12. The compound of claim 1, having the structure: 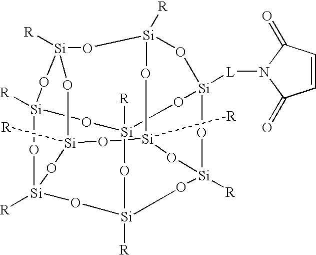
wherein:
R is methyl, ethyl, propyl, butyl, pentyl, hexyl, cyclohexyl, heptyl, or octyl, and
L is alkylene or oxyalkylene.

13. The compound of claim 12, wherein R is cyclohexyl.

14. The compound of claim 1, having the structure: 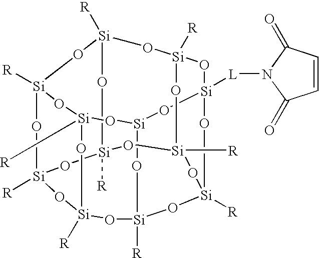
wherein:
R is methyl, ethyl, propyl, butyl, pentyl, hexyl, cyclohexyl, heptyl, or octyl, and
L is alkylene or oxyalkylene.

15. The compound of claim 14, wherein R is cyclohexyl.

16. A photosensitive resin composition comprising
a) a compound having the structure: 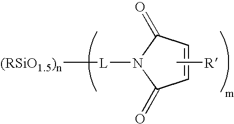
wherein:
R is alkyl, alkenyl, aryl, or alkoxy;
L is alkylene or oxyalkylene;
R′ is H or alkyl;
n is 6 to about 12;
m is 1 to about 12, and
d) a solvent.

17. The photosensitive resin composition of claim 16, further comprising a photosensitive agent.

18. The photosensitive resin composition of claim 17, wherein the photosensitive agent is about 2 weight percent (wt %) to about 10 wt % of the total composition.

19. The photosensitive resin composition of claim 16, further comprising a diluent.

20. A polymer comprising a plurality of monomers having the structure: 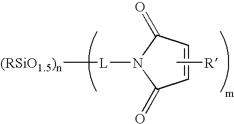
wherein:
R is alkyl, alkenyl, aryl, or alkoxy;
L is alkylene or oxyalkylene;
R′ is H or alkyl;
n is 6 to about 12; and
m is 1 to about 12.

21. An adhesive composition comprising at least compound of claim 1, and at least one curing initiator.

22. The adhesive composition of claim 21, wherein the at least one curing initiator comprises 0.1 wt % to about 5 wt % based on total weight of the composition.

23. The adhesive composition of claim 21, further comprising a compound selected from acrylates, methacrylates, maleimides, vinyl ethers, vinyl esters, styrenic compounds or allyl functional compounds.

24. The adhesive composition of claim 21, further comprising a reactive diluent.

25. The adhesive composition of claim 21, further comprising a filler.

26. The adhesive composition of claim 25, wherein the filler is conductive.

27. The adhesive composition of claim 25, wherein the filler is thermally conductive.

28. The adhesive composition of claim 21, wherein the filler is electrically conductive.

29. The adhesive composition of claim 21, wherein the filler is non-conductive.

30. The adhesive composition of claim 21, wherein the curing initiator comprises a free-radical initiator or a photoinitiator.
